(19) United States
(12) Patent Application Publication
(10) Pub. No.: US 2007/0024226 A1
(43) Pub. Date: Feb. 1, 2007

(54) Method and apparatus for controlling at least one electric drive of a vehicle

(75) Inventor: Gerhard Mersch, Uetze (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/489,056

(22) Filed: Jul. 19, 2006

(30) Foreign Application Priority Data
Jul. 26, 2005 (DE) 10 2005 034 918.8

(51) Int. Cl. G05D 3/00

(52) U.S. Cl. 318/466

(57) ABSTRACT

A method for controlling at least one electric drive of a vehicle includes comparing a value of an electric variable to a threshold. The electric variable relates to an operation of the electric drive or is derived from the operation of the electric drive. The electric drive is stopped or operated with a reduced value of the electric variable if the threshold is reached and/or if the threshold is exceeded. The threshold is specified by a permissible value of the electric variable relating to an operation of several electric drives.

### RELATED APPLICATIONS

The application claims priority to German Patent Application No. 10 2005 034 918.8, which was filed on Jul. 26, 2005.

### BACKGROUND OF THE INVENTION

The invention relates to a method and an apparatus for controlling at least one electric drive of a vehicle.

In recent years; the number of “x-by-wire” units in vehicles has increased, e.g., more and more devices within a car are electrically controlled. One example of an x-by-wire unit is a drive-by-wire unit where an accelerator signal from a pedal is electrically sensed and transmitted to a control unit that drives an engine to control acceleration. Another example is a brake-by-wire system. In this system, a brake pedal in a car is not a mechanical or hydraulic actuator that directly drives brakes. Instead, in a brake-by-wire system, a sensor, which is connected to a control unit, senses the period of time in which a driver moves from a gas pedal to the brake pedal and a force that is applied to the brake pedal (e.g. to determine emergency braking). This information can be used to determine braking power and to initiate more or less vehement braking.

As the x-by-wire systems are essential to the operation of a vehicle, it is very important that these systems be supported by a stable electronic system. The x-by-wire systems are particularly sensitive to voltage-drops, i.e. auxiliary systems or applications must not unduly load an electrical system of the vehicle.

For example, a the window regulator drive is activated to close a window, the window regulator drive usually needs an electric current of about 6 Ampere (A). Closing four windows at the same time requires an electric current of 24 A. Due to high friction, one window regulator drive may consume up to 20 A resulting in a current of 20 A+(3*6 A)=38 A, which would be needed for simultaneously closing four windows. Hence, vehicle voltage may decrease, which affects the sensitive x-by-wire systems. Alternatively, or in addition to, a fuse could be activated, i.e. blown, disadvantageously requiring the driver to replace the fuse before being able to close the windows.

The objective of the invention is to overcome the above-described disadvantages.

### SUMMARY OF THE INVENTION

A method is provided for controlling at least one electric drive of a vehicle, wherein a value of an electric variable is compared to a threshold. The electric variable relates to an operation of the electric drive or is derived from the operation of the electric drive. The electric drive is stopped or operated with a reduced value of the electric variable if the threshold is reached and/or exceeded. The threshold is specified by a permissible value of the electric variable relating to an operation of several electric drives.

This approach bears the advantages that the threshold of an electric value determined during operation of the at least one electric drive can be compared to a permissible value of the electric variable of several electric drives, i.e. the threshold could be higher if only one electric drive is activated.

If the threshold is reached or exceeded, the electric drive is stopped or, as an alternative, operated in a controlled mode, i.e. only a reduced value of the electric variable is applied to this particular electric drive. As an example, if the threshold is 7 A and the electric drive needs 20 A, current could be limited to substantially 7 A for a predetermined period of time. If 7 A is not sufficient to operate the electric drive, this electric drive will not be re-activated for a predetermined period of time. After such a period of time, the electric drive could be activated again, but again limited by the threshold. However, the threshold may have changed if other electric drives have finished their operation. If this particular electric drive is the only electric drive that is still in operation, the electric drive could be operated at the permissible value of the electric variable.

In one example embodiment, the electric variable may comprise at least one of the following variables: Electric current, voltage, or electric energy. The electric variable can be measured. There are numerous measurement techniques of electric variables that are known to one of ordinary skill. In particular, it is possible to measure one type of electric variable and derive another electric variable from such measurement.

As an alternative, the electric drive can be an electric drive to lift a pane, in particular the electric drive can be a window regulator drive. The electric drive can also operate an electric sunroof. Alternatively, or in addition to, the electric drive may also run various electrical systems or devices within a car, such as electric seats or electric shades, for example.

Operating the electric drive can mean driving up or driving down the pane, in particular opening or closing the pane.

In yet another embodiment, an anti-squeeze protection method and/or system could be provided, in particular as an option to the method/apparatus as described.

In one example embodiment, several electric drives are operated on the basis of the permissible value of the electric variable.

In an alternative embodiment, the threshold is determined on the basis of the number of electric drives activated. Alternatively, or in addition to, the threshold can be determined dynamically, e.g., after a certain time interval. In particular, the threshold can be determined (nearly) continuously based on a real-time application.

In particular, at least one electric drive can be operated in a multiplex-mode or in a step-by-step mode.

In an alternative embodiment, the electric drive is stopped when reaching the threshold whereas the remaining electric drives of the several drives are further operated.

As an example, a car comprises four window regulator drives to operate four windows I, II, III and IV. The electric variable to be measured is the electric current, and the permissible value of the electric variable is 24 A. Hence, the threshold for all four drives being simultaneously in operation is 6 A each. In this example, because of high friction, window I would need a current of 20 A to be closed. If all four windows are operated simultaneously, the threshold of 24 A will be exceeded. There are several possibilities to control the electric drives:

In one control configuration example, the electric drive operating window I (with a need for 20 A) could be brought to a halt, with the remaining electric drives having their threshold increased to 24 A/3=8 A each, enabling windows II, III and IV to be closed. After at least one of these three windows is closed, the threshold to be applied to window I increases to 24 A/3=8 A; after the second window closed, the threshold increases to 24 A/2=12 A; and finally, if all other windows are closed, 24 A could be applied to close window I. It is also possible to wait a predetermined period of time before trying to close window I again. This can be done dependent or independent from having a higher threshold available. For example, even if windows II, III, and IV are not yet closed, the drive of window I could be activated in a controlled manner to determine if window I still needs 20 A, i.e. whether the high friction is still present.

In another control configuration example, the electric drive operating window I could be brought to a halt, requiring re-activation by a user by pressing a button (“step-by-step mode”), for example. The electric drives of the remaining windows are further operated to close windows II to IV.

In another example, a control configuration operates in a multiplex-mode, where window I could be closed by applying the permissible value of 24 A to an associated electric drive, while the electric drives for windows II to IV are brought to a halt. After a predetermined period of time, the electric drive operating window I could be stopped and the remaining electric drives could be activated, also for a predetermined period of time, to simultaneously close windows II to IV. Hence, two time intervals allow a first group (window I) and a second group (windows II to IV) to be closed by turns. This approach is not limited to two groups. Each electric drive reaching or exceeding the threshold could define an additional group to be addressed by this multiplexing scheme.

If the available current of 24 A is not sufficient to move the window, this could be recognized, and the respective window could be brought to a permanent halt.

It is to be noted that beyond friction, other reasons for an increased value of the electric variable to operate a window may exist. Furthermore, the example described could be applied to opening a window as well as closing the window, or at least another window.

In one example embodiment, the permissible value of the electric variable amounts to substantially 30 A.

Another example embodiment is directed to at least one additional load that is operated together with the at least one electric drive. This additional load can be a heating device (for seats or a rear window defroster) or any other device consuming electric energy, such as an entertainment system (radio, CD-player, sound-system, navigation system), for example. Such load may additionally limit the permissible value of the electric variable. Furthermore, this load can be switched off in case additional energy is needed for the electric drive.

Furthermore, the problem is solved by an apparatus for operating at least one electric drive, in particular a window regulator drive, comprising a control unit formed such that the steps of the method as described can be executed.

These and other features of the present invention can be best understood from the following specification and drawings, the following of which is a brief description.

### BRIEF DESCRIPTION OF THE DRAWINGS

FIG. 1 is a schematic block diagram of a method for controlling at least one electric drive.

FIG. 2 is a block diagram of a system with several window regulator drives.

FIG. 3 is a schematic bus-structure of the block diagram according to FIG. 2.

### DETAILED DESCRIPTION OF THE PREFERRED EMBODIMENT

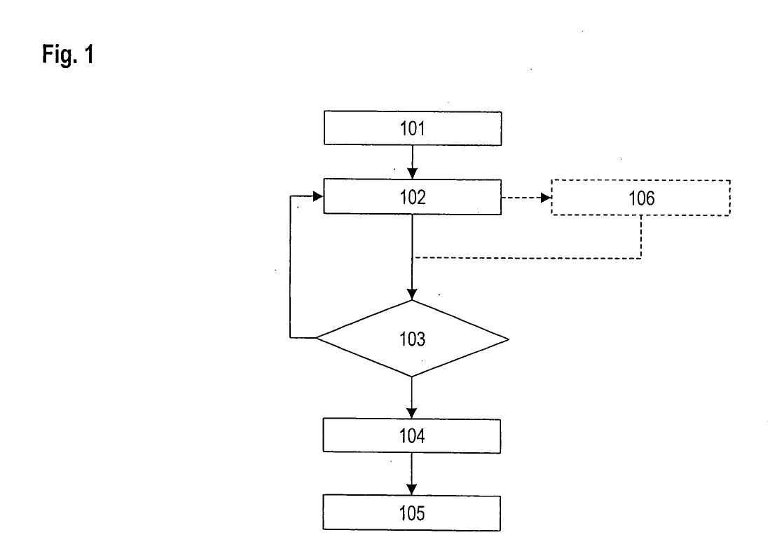

FIG. 1 shows steps of a method for controlling at least one electric drive provided in a motor vehicle. In a step 101, a user pushes a button in order to close (or open) at least one window. Alternatively, the user may push several buttons to operate several window regulator devices, or a single button could be provided to activate all window regulator devices.

In a subsequent step 102, a value of an electric variable, e.g. the electric current consumed, is measured for each electric drive.

The value of the electric variable is compared in a following step 103 with a threshold. If the threshold is reached or exceeded by a single window regulator drive, the method is branched to a step 104, otherwise the method is branched to step 102.

In step 104, the single window regulator drive is handled. This particular window regulator drive requires a higher value of the electric variable, here the electric current, than allowed by the permissible value of the electric variable for operating several electric devices. Hence, this window regulator drive could be brought to a halt, and could enter a so-called “step-by-step” mode. In this mode, the user manually triggers the drive, which moves the window only a certain amount before reaching the threshold again, or the drive does not move the window at all, such as if there is too much friction. This mode also allows the user to receive feedback of the malfunction of the drive. One reason for such malfunction may be high friction of the window.

As an alternative, the window regulator drives may be operated in an alternating mode. A window regulator drive that requires more electric current than available could define an additional group to be solely operated for a certain amount of time before and/or after the remaining window regulator drive(s) are also operated for a certain amount of time. This bears the advantage that, while being active, each group has an increased amount of current available to operate the window regulator drives summarized within the respective group (“multiplex-mode”).

Furthermore, the window regulator drive reaching its threshold could be controlled by applying the threshold current continuously or in a pulsed mode to close (open) the window. This could be done automatically or initiated by the user, e.g., by pressing the close (or open) button. In addition, this controlled operation of the window regulator drive could last a predefined amount of time, and then could stop in case the window is still not closed (or open). This method could be applied together with the concept as set forth above, according to which a permissible value of the current can be applied dependent on the number of additional active drives. For example, if no other drive is active, the permissible value could be applied to this single window regulator drive trying to close (open) the window.

As an option, in a step 105 the user could receive a feedback about the defect. This is achieved, for example, by entering the step-by-step mode wherein the user recognizes that the window has ceased to move and only proceeds a certain amount when activated again. Another possibility for a response to the user is an audio and/or visual feedback, e.g., producing a tone and/or a light or signal indicating the defect. Hence, the user is able to react by manually closing the window or by activating an override-function, such as keeping the button pressed until the window is closed (or open), for example.

A step 106 could be optionally inserted between step 102 and step 103 thereby replacing the arrow between step 102 and step 103. Step 106 comprises an anti-squeeze method/system taking the result of the measurement of step 101 to stop the window regulator drive if a squeeze situation is detected. The anti-squeeze method/system may work in addition to the method/system as described herewith, in particular the anti-squeeze method may evaluate the dynamic current consumption of the window regulator drive in order to determine the anti-squeeze situation.

Advantageously, the method is implemented in a controller and/or microprocessor comprising several memory fields for universally storing parameters of the method. This would allow an easy change of the system, in particular an easy adaptation of the method/system to different applications. An example for generic fields to be provided relate to the following values: critical power consumption caused by high friction; usual power consumption; and step-by-step activation time.

The first value allows for comparison of the power consumption with a predefined value to determine whether the window regulator drive is working properly.

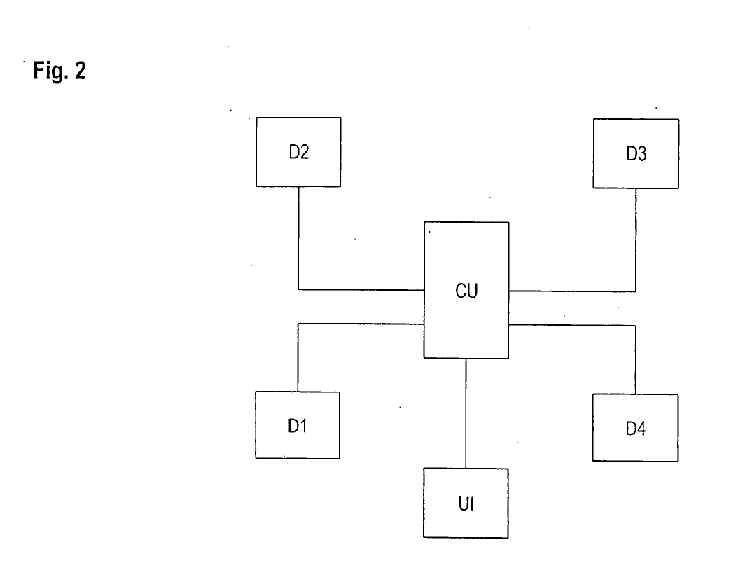

FIG. 2 shows a block diagram of a system with several window regulator drives. This star-shaped arrangement comprises a control unit CU to which window regulator drives D1, D2, D3 and D4 are connected. In addition, a user interface UI is also connected to the control unit CU.

The control unit CU evaluates the current consumed by each window regulator drive D1, D2, D3, and D4 and compares this current value with a predefined value. In addition, as described in detail, the threshold for each window regulator drive D1, D2, D3, and D4 can be derived from a permissible (overall) value for all drives D1 to D4. As the control unit CU is able to determine the consumption of the drives connected, it can also limit the consumption to the permissible value, e.g., by the step-by-step mode or the multiplex-mode as described supra.

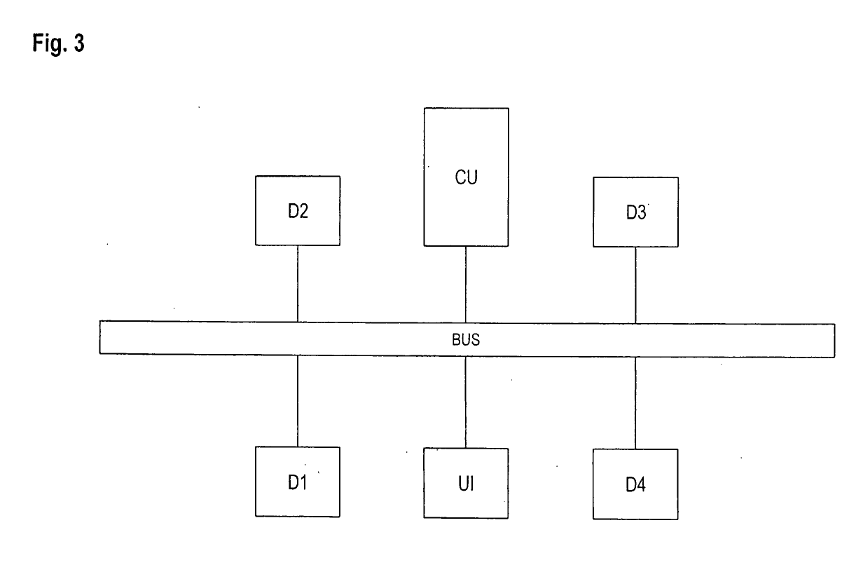

An alternative to the star-shaped arrangement of FIG. 2 is suggested by a bus-structure according to FIG. 3. The same components of FIG. 2 are connected to a BUS. The BUS can be a CAN-BUS or any other bus-structure that may be of advantage.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for controlling at least one electric drive of a vehicle comprising the steps of:
comparing a value of an electric variable that relates to an operation of the at least one electric drive to a threshold;
performing one of stopping the at least one electric drive and operating the at least one electric drive with a reduced value of the electric variable if the threshold is at least one of being reached and exceeded; and
specifying the threshold by a permissible value of the electric variable for operating several electric drives.

2. The method according to claim 1, wherein the electric variable comprises at least one of an electric current, a voltage, and an electric energy.

3. The method according to claim 1, including measuring the electric variable.

4. The method according to claim 1, wherein the at least one electric drive is a window regulator drive.

5. The method according to claim 4 including operating the window regulator drive to control movement of a pane.

6. The method according to claim 4, including providing an anti-squeeze system.

7. The method according to claim 1, including operating the several electric drives on a basis of the permissible value of the electric variable.

8. The method according to claim 1, including operating the at least one electric drive in a multiplex-mode.

9. The method according to claim 1, including operating the at least one electric drive in a step-by-step mode.

10. The method according to claim 1, including stopping the at least one electric drive when the threshold is reached, while still operating any remaining drives of the several electric drives.

11. The method according to claim 1, wherein the permissible value of the electric variable is approximately 30 Ampere.

12. The method according to claim 1, including determining the threshold based on a number of electric drives activated.

13. The method according to claim 1, including dynamically determining the threshold.

14. The method according to claim 1, including operating at least one additional load together with the at least one electric drive.

15. An apparatus for operating at least one electric drive of a vehicle comprising:
a control unit that compares a value of an electric variable that relates to an operation of the at least one electric drive to a threshold, performs one of stopping the at least one electric drive and operating the at least one electric drive with a reduced value of the electric variable if the threshold is at least one of being reached and exceeded, and specifies the threshold by a permissible value of the electric variable for operating several electric drives.

16. The apparatus according to claim 15 wherein the at least one electric drive comprises a window regulator drive.
